(19) United States
(12) Patent Application Publication
(10) Pub. No.: US 2008/0190214 A1
(43) Pub. Date: Aug. 14, 2008

(54) Cut-back flow straightener

(75) Inventors: John Ubowski, Santa Clarita, CA (US); Bogdan Marcu, Sierra Madre, CA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Pratt & Whitney Rocketdyne, Inc., Canoga Park, CA (US)

(21) Appl. No.: 11/899,824

(22) Filed: Sep. 7, 2007

Related U.S. Application Data
(63) Continuation-in-part of application No. 11/704,038, filed on Feb. 8, 2007.

(51) Int. Cl. G01F 1/80

(52) U.S. Cl. 73/861.351; 29/889.22; 73/861.79

(57) ABSTRACT

A cutback flow straightener comprises a plurality of flow straightener vanes positioned in a flow duct. The flow straightener vanes are cut back as a function of a radius of the flow duct, such that an axial length of the vanes decreases with the radius.

### CROSS-REFERENCE TO RELATED APPLICATION

This is a continuation-in-part of U.S. patent application Ser. No. 11/704,038, entitled “TAPERED, FREQUENCY-TUNED ROTOR FOR TURBINE FLOW METER,” filed Feb. 8, 2007 by B. Marcu et al., now pending.

### STATEMENT OF GOVERNMENT INTEREST

This invention was made with U.S. Government support under contract numbers NASA8-45000 and NAS8-01240, awarded by the National Aeronautical and Space Administration. The U.S. Government may have certain rights in this invention.

### BACKGROUND

This invention relates generally to fluid flow, and in particular to flow straightening. Specifically, the invention concerns a cut-back flow straightener configurable for use with a turbine flow meter.

Contemporary aerospace applications, both commercial and scientific in nature, are characterized by increasing payload demands. These payloads can require millions of pounds-force in liftoff thrust, which must be managed with precision dynamical control in order to maintain a viable flight path and achieve stable orbit. This raises a number of technical design challenges. Among these, the fuel-oxidant mixture ratio remains a key issue for rocket motor design. Maintaining the correct mixture ratio requires precise measurement and control of extremely high-rate and highly variable fuel and oxidant flows, each with tolerances below one percent.

There are two basic approaches to maintaining the fuel-oxidant mixture ratio: solid-fuel and liquid-fuel designs. Solid-fuel rocket motors employ premixed fuel and oxidant, guaranteeing the correct ratio and obviating the need for flow control. Unfortunately, solid-rocket technology has significant limitations. Once ignited, solid rocket motors essentially cannot be shut down. A limited degree of burn rate management can be achieved by tailoring the fuel profile (that is, the surface area available for burn), and some level of attitude control can be achieved via gimbaled nozzles. These techniques are insufficient, however, to achieve the precision required for stable earth orbit, much less an interplanetary trajectory. For these and other technical reasons solid-fuel rocket motors are generally limited to specific power applications such as providing liftoff thrust, with the space shuttle's Solid Rocket Booster (SRB) as a primary example.

Orbital and interplanetary spaceflight thus require liquid-fuel rocket motor technology, which in turn requires precise control of the fuel-oxidant ratio. The problem is generally approached via a series of low-pressure and high-pressure fuel and oxidant pumps, each with feedback control provided by flow meters. The flow meters themselves fall into two general categories, which employ either indirect or direct measurement techniques.

Most indirect flow meters incorporate differential pressure technology, which in turn depends upon Bernoulli's Principle. Neglecting the gravitational potential, Bernoulli's Principle may be expressed in a simple form of Bernoulli's Equation:

$$Δ P = \frac{1}{2} ρΔ ( {v}^{2} ) . \qquad [ 1 ]$$

Eq. 1 relates the pressure differential ΔP across a small region of restricted flow to one-half the flow density (ρ) times the difference in the square of the flow velocity, which is Δ(v²). This allows a differential pressure flow meter to compare a high-pressure, low-velocity flow on one side of the restriction to a low-pressure, high-velocity flow on the other side of the restriction.

Differential pressure flow meters can be designed so that they introduce no moving parts into the flow stream, which is a clear advantage for high-velocity, high-volume flows. Nonetheless the technology exhibits disadvantages as well. Differential pressure flow meters measure relative flow velocity, not absolute flow, and the relationship between flow and differential pressure is not linear. Differential pressure measurements also require a mechanical flow restriction, which limits overall capacity and introduces turbulence. The pressure drop ΔP, moreover, cannot be fully recovered even in sophisticated Venturi tube designs. This requires additional pumping capacity, limits performance, and compromises efficiency.

Pitot tubes operate in a related fashion, by determining the kinetic energy of the flow as a function of pressure. The mathematical relationship remains nonlinear, therefore, because kinetic energy also depends upon the square of the flow velocity (v²). Pitot technology is also less appropriate to liquid flows than to compressible fluid flows, and is thus generally restricted to gaseous applications like air speed indicators. Like all differential pressure devices, moreover, Pitot tubes provide point-like measurements that can be relatively insensitive to non-uniformities such as laminar flow and turbulence. To the extent that these non-uniformities approach even one percent of the total flow, they may impose mission-critical limits on the mixture ratio.

Electromagnetic induction flow meters provide a different approach, by measuring the current induced in a conductive flow as it passes through a region of strong magnetic field. The induced current depends linearly on the flow rate, rather than its square. Electromagnetic induction flow meters are further bi-directional, and can be applied to corrosive solutions and hazardous wastes for which other technologies are inappropriate.

Few of these advantages, however, are directly applicable to rocket motor design. Electromagnetic induction flow meters require an external magnetic coil structure, which is costly in terms of both space (size envelope) and mass (weight). The induction of a strong electric current loop in the flow also poses technical, safety and reliability concerns. This makes induction-based flow measurement impractical for most liquid-fuel rocket motor designs, and in particular for liquid hydrogen (LH2) applications on the Space Shuttle Main Engine (SSME).

In contrast to indirect measurement techniques, turbine flow meters are lightweight, space efficient, and provide a direct, linear measurement of the absolute flow rate. Moreover, turbine flow meters can be deployed with flow straighteners that minimize turbulence, rather than generate it, and do not introduce substantial flow restrictions or pressure drops.

Turbine flow meters must operate directly in the flow, however, which in the case of the SSME may exceed ten thousand gallons per minute (630 l/s) of LH2. This subjects the flow meter to significant stress, particularly in regions of turbulent flow. There is an ongoing need for flow straightener and rotor designs that address this issue, with specific focus on the problem of wake-field effects immediately downstream of the flow straightener.

### SUMMARY

This invention concerns a cut-back flow straightener configurable for deployment upstream of a turbine flow meter rotor. The flow straightener comprises a plurality of flow straightener vanes, which form flow channels within a flow duct. The vanes are cut back from the rotor, such that the flow straightener's axial length decreases with the radius of the flow duct, and the separation of the flow straightener from the rotor increases toward the rotor blade tips.

### BRIEF DESCRIPTION OF THE DRAWINGS

FIG. 1 is a cutaway view of a flow duct, showing a cutback flow straightener in an embodiment comprising primary and secondary flow straighteners.

FIG. 2 is an enlargement of the flow duct in FIG. 1, showing the secondary (cutback) flow straightener of FIG. 1.

FIG. 3A is a cross-sectional side view of the flow duct in FIG. 2, showing a prior art (non-cutback, or “straightback”) flow straightener.

FIG. 3B is a cross-sectional side view of the flow duct in FIG. 2, showing the cutback flow straightener.

FIG. 4A is a cross-sectional end view showing the cutback flow straightener of FIG. 3B, in a hexagonal or “honeycomb” configuration.

FIG. 4B is a cross-sectional end view showing the cutback flow straightener of FIG. 3B, in an orthogonal or “egg crate” configuration.

FIG. 4C is a cross-sectional end view showing the cutback flow straightener of FIG. 3B, in a triangular configuration.

FIG. 4D is a cross-sectional end view showing the cutback flow straightener of FIG. 3B, in a tubular configuration.

### DETAILED DESCRIPTION

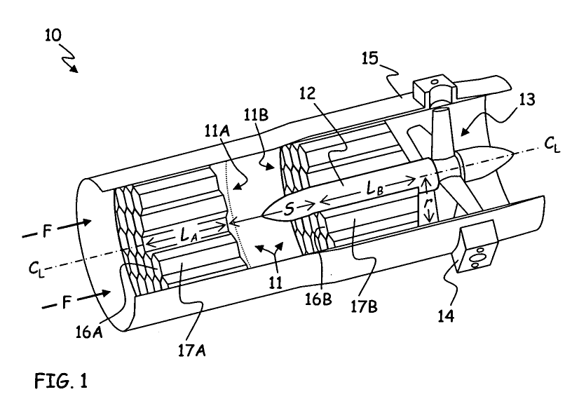

FIG. 1 is a cutaway view of flow duct 10, showing cutback flow straightener 11. In this embodiment, cutback flow straightener 11 comprises primary flow straightener 11A and secondary flow straightener 11B.

Flow within duct 10 is downstream and substantially axial; that is, from left to right and generally parallel to centerline axis C_{L} as illustrated by flow arrows F. Primary flow straightener 11A is upstream of (that is, in an upstream direction from) secondary flow straightener 11B, and turbine flow meter 12 is mounted in secondary flow straightener 11B such that rotor 13 is oriented in a downstream direction, proximate flow meter boss 14.

Flow duct 10 comprises generally cylindrical duct wall 15 and flow meter boss 14. In preferred embodiments, the material of duct wall 15 has a glass transition temperature T_{g} below −223° C., such that the material does not undergo a glass transition when reduced to the temperature of liquid oxygen (LOX). In some of these embodiments, the material has a glass transition temperature T_{g} below about −253° C., and does not undergo a glass transition when reduced to the temperature of liquid hydrogen (LH2). In further preferred embodiments, the material of duct wall 15 is a corrosion-resistant (CRES) material such as 21-6-9 stainless steel (also known as 21cr-6ni-9mn stainless, or UNS S21904).

In the dual-component embodiment of FIG. 1, cutback flow straightener 11 comprises primary (upstream) flow straightener 11A and secondary (downstream) flow straightener 11B. Primary flow straightener 11A comprises primary flow channels 16A and primary straightener vanes 17A. Secondary flow straightener 11B comprises secondary flow channels 16B and secondary straightener vanes 17B.

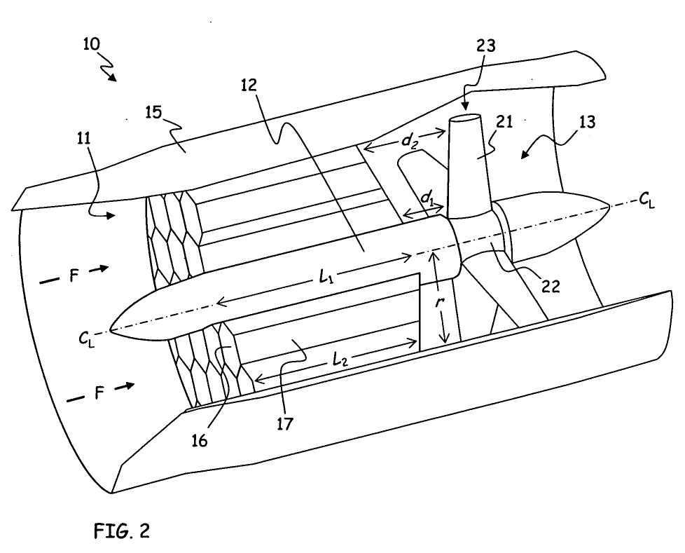

Secondary (downstream) flow channels 16B and vanes 17B are cut back, such that the axial length of secondary flow straightener 11B decreases as a function of the radius r of flow duct 10. Typically, maximum axial length L_{B} lies along axial centerline C_{L}, and secondary flow straightener 11B is cut back from rotor 13 such that the axial separation increases along the rotor blades, as discussed with respect to FIG. 2, below.

In a preferred embodiment, cutback flow straightener 11 is comprised of the same material as duct wall 15. This reduces the effects of differential thermal expansion. In other embodiments, the composition of flow straightener 11 differs from that of duct wall 15, and in some of these embodiments the compositions of primary flow straightener 11A and secondary flow straightener 11B differ from one another.

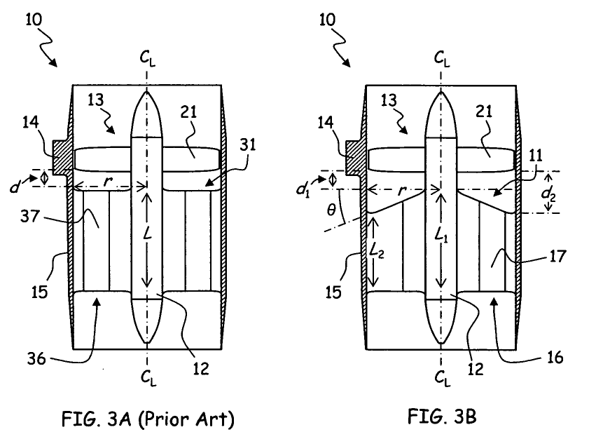

In the particular embodiment of FIG. 1, flow straightener vanes 17A, 17B are corrugated to form hexagonal (or honeycomb) flow straightener channels 16A, 16B. In other embodiments this geometry varies, as described with respect to FIGS. 3A-3D, below. In a preferred embodiment, primary vanes 17A and secondary vanes 17B have a similar structure, such that the cross section of primary flow channels 16A and secondary flow channels 16B is the same (as shown in FIG. 1). In other embodiments, the vane and channel configurations of primary flow straightener 11A and secondary flow straightener 11B vary. In further embodiments, cutback flow straightener 11 is a unitary structure, without distinct primary (upstream) and secondary (downstream) components (see FIG. 2).

Flow straightener channels 16A, 16B and vanes 17A, 17B straighten the flow within duct 10 by reducing rotation and turbulence before impingement on turbine flow meter rotor 13. In the SSME LH2 duct configuration illustrated by FIG. 1, cutback (secondary) flow straightener 11B also provides structural support for turbine flow meter 12, orienting the flow meter axially within LH2 flow duct 10 with boss 14 and rotor 13 are downstream of cutback flow straightener 11A.

As illustrated in FIG. 1, secondary flow straightener 11B has a cutback configuration, in which the axial length of flow channels 16B and vanes 17B decreases with radius r. Primary (upstream) flow straightener 11A, in contrast, typically has a non-cutback or “straightback” configuration, in which the axial length is uniform with radius. In alternate embodiments, both primary flow straightener 11A and secondary flow straightener 11B have cutback configurations. In these embodiments, a primary flow meter rotor is sometimes positioned between primary flow straightener 11A and secondary flow straightener 11B, and this rotor often counter-rotates with respect to rotor 13.

The two-component primary/secondary flow straightener configuration of FIG. 1 has important advantages. In particular, some prior art flow straightener configurations require an axial length of many times the flow duct diameter in order to provide sufficient straightening, particularly after a turbulence-inducing structure such as a bend in the flow duct. In contrast, primary flow straightener 11A allows cutback flow straightener 11 to achieve sufficient flow straightening when maximum axial lengths L_{A} and L_{B} are each on the order the flow duct diameter.

Specifically, the maximum axial lengths of primary flow straightener 11A and secondary flow straightener 11B are each less than three times inside radius of flow duct 10 (that is, L_{A}<3r and L_{B}<3r). Further, minimum axial separation S, as measured axially from the closest point of primary flow straightener 11A to the closest point of secondary flow straightener 11B, is also on the order of the flow duct diameter (specifically, r<S<3r). As a result, the total length of two-component primary/secondary flow straightener 11 is less than five times the diameter of the flow duct (L_{A}+L_{B}+S<10r).

In the particular embodiment of FIG. 1, flow duct 10 is a liquid hydrogen duct for the space shuttle main engine (the SSME LH2 duct), situated between an upstream low-pressure fuel pump discharge (located to the left of FIG. 1), and a downstream high-pressure pump intake (located to the right of FIG. 1). The diameter of the SSME LH2 flow duct is 5.200 inches (5.200″, or 15.208 cm), as defined by the inner dimension of duct wall 15. The corresponding (inner) flow duct radius r is 2.600″ (6.604 cm).

In alternate embodiments, flow duct 10 is another liquid rocket fuel flow duct for either liquid hydrogen (LH2) or liquid oxygen, and these dimensions vary. The lightweight, reliable and space-efficient design of cutback flow straightener 11 is also applicable to more general cryogenic flow applications, including, but not limited to, liquid argon, liquid nitrogen, liquefied or supercritical carbon dioxide (CO2), liquid methane, and propane, butane, or other liquefied petroleum gas (LPG) products. Flow straightener 11 is also applicable to non-cryogenic fluids including, but not limited to, water, petroleum products, petrochemical products, food products, and other industrial fluid processing applications. In these embodiments flow duct 10 typically has a circular cross section, as shown in FIG. 1, but the design of cutback flow straightener 11 is also adaptable to rectangular, triangular, elliptical, and other cross sections, in which radius r is defined by another, analogous radial measurement.

FIG. 2 is an enlargement of flow duct 10, showing secondary (cutback) flow straightener 11. In this embodiment cutback flow straightener 11 is a unitary structure comprising a single set of flow channels 16, which perform analogously to primary and secondary channels 16A, 16B, and a single set of straightener vanes 17, which perform analogously to primary and secondary vanes 17A, 17B.

As shown in FIG. 2, flow channels 16 and vanes 17 of cutback flow straighter 11 terminate approximately in a cone oriented perpendicularly to axial centerline C_{L}. The apex of the cone lies along axial centerline C_{L}, such that the axial length of flow channels 16 and vanes 17 decreases linearly with radial measurement r, from maximum value L₁, typically proximate axial centerline C_{L} (that is, corresponding to maximum axial length L_{B} of secondary flow straightener 11B in FIG. 1), to minimum length L₂ proximate the inside of duct wall 15 (at radius r). This contrasts with the straightback configuration illustrated for primary (upstream) flow straightener 11A of FIG. 1, which terminates generally in a plane perpendicular to axial centerline C_{L}, with substantially uniform axial length L_{A}. In some embodiments, where flow straightener 11 does not terminate in a cone but has a more complex termination, maximum axial length L₁ does not fall along centerline C_{L} but instead lies at an intermediate position between C_{L} and maximum inner radius r.

In contrast to differential pressure flow measurement techniques in the prior art, cutback flow straightener 11 and flow meter 12 create a flow measurement system without a substantial flow restriction. This reduces turbulence, rather than creates it, particularly where the flow is incident on rotor 13. While differential pressure techniques also sample only a portion of the total flow, furthermore, turbine flow meter 12 is positioned such that rotor 13 sweeps out essentially the entire circular cross section of flow duct 10, providing a more precise, integral flow measurement system that incorporates both bulk axial flow and non-uniformities due to residual turbulence or regions of locally variable laminar flow.

Cutback flow straightener 11 and flow meter 12 also address deficiencies of prior art turbine flow meter designs. Specifically, the axial length of cutback flow straightener 11 decreases as a function of radius r, such that the distance between rotor 13 and flow straightener 11 increases along rotor blades 21. In the embodiment of FIG. 2 this decrease is linear, such that the separation is least proximate rotor hub 22 (d₁), and greatest proximate blade tip 23 (d₂). This reduces the effect of residual turbulence and non-uniform flow on rotor 13, lowering operational stresses on flow meter 12 and increasing its accuracy.

Turbine flow meter 12 measures the volumetric flow rate v directly from the rotational speed of rotor 13, rather than an indirect method involving a power of the velocity, such as v². This yields a very nearly linear relationship between rotational speed and flow rate, which is applicable over a wide operational range. The linearity is typically characterized by calibration factor K_{f}, which is given by

K_{f}=4·RPM/GPM. [2]

Calibration factor K_{f} relates the rotor speed (in rotations per minute, or RPM) to the volumetric flow rate in gallons per minute (GPM; alternatively, Eq. 2 can be adjusted to yield the flow rate in liters per second, or l/s). The calibration factor typically includes an explicit factor of four to account for the four-blade design of rotor 13, but in other embodiments the number of blades varies and Eq. 2 is adjusted accordingly.

Turbine flow meter 12 is located in a region of high operational stress, due both to the high flow rate and because of residual wake effects downstream of flow straightener 11. In particular, as rotor 13 rotates through successive momentary stall regions in the wake, it experiences periodic excitations at a frequency determined by the rotor speed and by the geometrical structure of flow straightener 11. For the hexagonal configuration of FIG. 2, for example, the relevant frequencies depend upon the “12N” symmetry pattern, which is characteristic of the vertex spacing in hexagonal tiling, and, in some embodiments, the “18N” pattern, which is characteristic of the edge spacing.

Essentially, the 12N pattern excites rotor 13 at twelve times the rotational speed, and the 18N pattern excites rotor 13 at eighteen times the rotor speed. At rotational speeds approaching 4,000 RPM, therefore, the 12N symmetry pattern excites rotor 13 at about 800 Hz, and the 18N symmetry pattern at about 1,200 Hz. If either of these frequencies (or other excitation frequencies, associated with other flow straightener symmetries and other rotational speeds) approaches a natural oscillation mode of rotor 13, a number of problematic phenomena are observed. Specifically, these are rotor speed fluctuations, aliasing, and “K_{f} shifting,” which is an apparent shift in the value of calibration factor K_{f}. The phenomenon of K_{f} shifting is not associated with an actual change in the LH2 flow rate, but is a resonance effect that decreases the precision and accuracy of rotor speed 12. The accompanying rotor speed fluctuations indicate operational stresses on rotor 13, which can, under some conditions, pose a mission-critical risk.

The actual frequency of rotor speed fluctuations is difficult to precisely measure, because the rotor speed is sampled only four times per rotation. Rotor speed sampling is accomplished via a magnetic inductive pickup, which registers a “pip” each time a rotor blade tip passes a fixed location along the rotor arc (that is, four pips per revolution). The 12N excitation frequency is necessarily a harmonic of the pip frequency, because both depend upon the rotational speed. This introduces beats between the rotor speed fluctuations and the pip frequency, a phenomenon referred to as “aliasing.”

Aliasing masks the true rotor speed fluctuation frequency. In prior art configurations, however, the phenomenon is experienced at rotor speeds in excess of 3,800 RPM, which is associated with the 12N hexagonal symmetry pattern. At these speeds the 12N pattern excitation frequency approaches a broad natural resonance of the prior art rotor, centered on approximately 830 Hz.

This problem is addressed in two ways. First, and in contrast to prior art designs, the axial separation between flow straightener 11 and rotor 13 increases along blade 21, such that it maximum value d₂, proximate blade tips 23, is greater than its minimum value d₁, proximate rotor hub 22. This increases the distance from blade tips 23 to the wake field of flow straightener 11, reducing the impact of aliasing and related effects. The cutback design also produces a more uniform flow field proximate blade tips 23, increasing the accuracy and precision of flow measurements in this region.

Second, in preferred embodiments the blades of rotor 13 are tapered such that the cross-sectional profile decreases with radius. In particular, blades 21 are taped such that the cross-sectional profile at each radius r corresponds to a modified NACA (National Advisory Committee for Aeronautics) four-digit series airfoil profile.

Tapering has a number of important design advantages, which complement the independent advantages of cutback flow straightener 11. Tapering increases the natural frequency of the first and second bending modes, from approximately 830 Hz to approximately 1500 Hz, which is outside the range of operationally-induced excitation frequencies associated with 12N and 18N wake symmetries. Tapering also reduces the effects of wake structures in the region proximate rotor hub 22, where separation d₁ between rotor 13 and flow straighter 11 is least, by increasing the relative chord length and thickness of rotor blades 21. This makes the blades stronger, and more resistant to induced oscillations and other operational stresses. Tapering also increases the sensitivity of rotor blades 21 toward blade tips 23 (at higher radius r), where separation d₂ between rotor 13 and flow straightener 11 is greater. This increases the relative accuracy of flow meter 12 by more heavily weighting the region of more uniform flow.

In the preferred embodiment FIG. 1 (above), configured for the SSME LH2 duct, the combination of cutting back flow straightener 11 and tapering rotor 13 extends the operational range of the prior art flow meter from 3,800 RPM to 4,000 RPM. This increases the total thrust capacity of the SSME, while maintaining the required accuracy of substantially less than one percent, and preferentially about point two percent (0.2%).

FIG. 3A is a cross-sectional side view of flow duct 10, showing prior art (non-cutback, or “straightback”) flow straightener 31. As discussed above, straightback flow straightener 31 terminates along a plane perpendicular to axial centerline C_{L}, such that flow channels 36 and vanes 37 have substantially uniform axial length L. In this prior art configuration, axial separation d between flow straightener 31 and rotor blades 21 is also substantially uniform; that is, approximately invariant with respect to radius r.

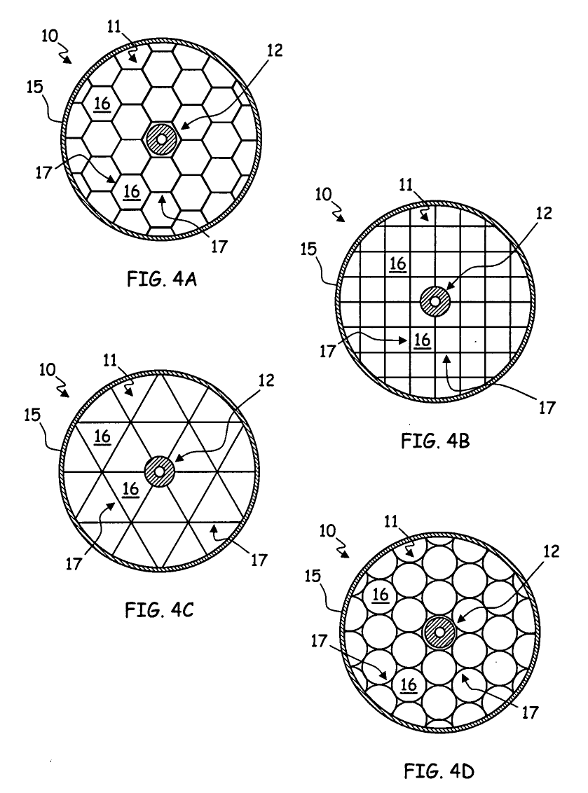

Note that in the SSME LH2 embodiment of duct 10, rotor 13 was first deployed approximately two inches (2″, or 5.08 cm) behind an “egg crate” flow straightener design, and then redeployed approximately one inch (1″, or 2.54 cm) behind a hexagonal or “honeycomb” design (compare FIGS. 4A, 4B). This reconfiguration not only introduced the 12N (and 18N) symmetry patterns, but also effectively halved the gap between rotor blades 21 and (secondary/downstream) flow straightener 31, significantly increasing wake field effects that include aliasing, rotor speed fluctuations, and K_{f} shifting. These problems were addressed by tapering the rotor, as discussed above, and by cutting back the flow straightener.

FIG. 3B is a cross-sectional side view of flow duct 10, showing cutback flow straightener 11. In this embodiment, cutback flow straightener 11 terminates along a cone perpendicular to axial centerline C_{L}. The apex of the cone is along centerline C_{L}, so that cutback vanes 17 and cutback flow channels 16 terminate approximately along a line at angle θ with respect to radius r. The axial length of cutback flow channels 16 and cutback vanes 17 thus decreases approximately linearly with radius r, according to the trigonometric functions of cutback angle θ.

In typical embodiments, cutback angle θ is at least ten degrees (10°) and no more than thirty degrees (30°). In the preferred embodiment, and as configured for the SSME LH2 duct, cutback angle θ is between twenty-two degrees (22°) and twenty-three degrees (23°), preferentially twenty-one degrees and twenty-four minutes (21° 24′). In this embodiment, cutback flow straightener 11 reduces the wake field intensity by 30-40% for radius r near the interior of duct wall 12, as determined by computational fluid dynamics (CFD) models of the flow velocity and comparison to non-cutback (straightback) designs in the prior art.

In the conical cutback embodiment, the axial length of flow straightener 11 has a maximum value L₁, typically located proximate centerline C_{L}, and a minimum value L₂, typically proximate inner radius r of duct wall 15. In this configuration, maximum value L₁ corresponds to maximum axial length L_{B} of secondary (downstream) flow straightener 11B along centerline C_{L} (compare FIG. 3B to FIG. 1, above).

In alternate embodiments, cutback flow straightener 11 does not terminate along a cone, so that vanes 17 and flow channels 16 do not form a uniform cutback angle θ with respect to radius r. In these embodiments, the decrease in axial length is an arbitrary function of radius r, rather than linear in r. Minimum axial length L₁ is typically located at a greater radius r than maximum length L₂, but the relative locations are otherwise arbitrary. In these embodiments, minimum value L₁ is generally at least ten percent less than maximum value L₂, and in preferred embodiments minimum value L₁ is at least twenty-five percent less than maximum value L₂.

In some embodiments, minimum axial separation d₁ between cutback flow straighter 11 and rotor 13 is the same as uniform axial separation d for the prior art (straightback flow straightener 31), as shown in FIG. 3A. In other embodiments, separation d₁ differs from the prior art value. In the particular embodiment of SSME LH2 duct, for example, d₁, exceeds d by approximately 0.0775 inches (0.0775″, or 1.97 mm), indicating an increased minimum spacing for the straightback configuration of FIG. 3A, with respect to the cutback configuration of FIG. 3B.

FIGS. 4A-4D are a cross-sectional end views of flow duct 10, illustrating cutback flow straightener 11 with a variety of channel and vane geometries. In each of these figures, flow meter 12 is supported by vanes 17 along the axis of flow duct 10, such that the rotor is located downstream of (behind) flow straightener 11, and thus is not shown.

FIG. 4A shows cutback flow straightener 11 in a hexagonal or “honeycomb” configuration. In this embodiment, vanes 17 are corrugated in order to form hexagonal flow channels 16. Flow meter 12 is supported in a central hexagonal flow duct, and the hexagonal pattern merges with the inner cylindrical surface of duct 10 at duct wall 15.

The honeycomb configuration of FIG. 4A introduces 12N and 18N symmetry patterns into the wake field, as discussed above, but also overcomes certain disadvantages of prior art designs. In particular, the hexagonal configuration does not exhibit the same degree of braze joint cracking at the intersections of vanes 17 as prior art rectangular (or orthogonal) configurations (see FIG. 4B), and approximates the “standard” general-purpose tubular design (see FIG. 4D) without introducing the same degree of flow blockages or “dead spaces” between flow channels 16.

FIG. 4B shows cutback flow straightener 11 in an orthogonal or “egg crate” configuration. In this embodiment, orthogonal vanes 17 form rectangular flow channels 16, and preferentially form square flow channels 16. Flow meter 12 is typically supported at the intersection of a pair of diametrical vanes 17, but in other embodiments the flow meter is supported in a central flow channel, analogously to the structure of FIG. 4A.

Note that FIG. 4B distinguishes from straightback egg crate configurations in the prior art. In these configurations, the turbine support structure is cut back as a function of radius, but the flow straightener itself (that is, vanes 17 and flow channels 16) is not. Prior art “egg crate” flow straighteners have exhibited braze joint cracking, as discussed above, but this problem can be addressed by improved construction techniques as well as redesigning the flow structure geometry.

Advantageously, the orthogonal configuration of FIG. 4B eliminates 12N and 18N symmetry patterns, which depend upon hexagonal (or triangular) geometries. It does, however, introduce 4N symmetries and their harmonics, and may introduce other symmetries as well. This illustrates an important aspect of the cutback flow straightener design technique.

While cutback flow straightener 11 inherently reduces wake field effects, by increasing the rotor-flow straightener separation as a function of radius, it is also important to select a vane and channel geometry that is appropriate to the particular application at hand. In particular, given the expected range of operational conditions (particularly, flow rates and rotational speeds), the geometry of cutback flow straightener 11 should not produce a wake field that excites a flow meter rotor, or any other structural element, near its natural frequencies of oscillation (that is, the wake field should not excite the flow measurement system's resonant modes).

FIG. 4C shows cutback flow straightener 11 in a triangular configuration. In this embodiment, vanes 17 form triangular flow channels 16, and preferentially form equilateral flow channels 16. This configuration combines the simple planar vane design of the egg crate configuration (FIG. 4B) with a strong triangular structure that exhibits wake field symmetries more similar to those of hexagonal designs (FIG. 4A).

The embodiment of FIG. 4C also exhibits that the typical cross-sectional area of flow channels 16 need not correspond to the cross-sectional area of flow meter 12, as it happens to do, for example, for the particular hexagonal configuration of FIG. 4A. The triangular embodiment also illustrates that the interfaces between flow channels 16 and duct wall 15 (and at flow meter 12) sometimes introduce nonuniformities into the flow channel pattern, without substantial effect on the operation of the cutback flow straightener.

FIG. 4D shows cutback flow straightener 11 in a tubular configuration. In this embodiment, vanes 17 are formed of elliptical or tubular flow channels 16, preferentially cylindrical (circular) flow channels.

As opposed to the hexagonal, orthognonal, and triangular configurations of FIGS. 4A-4C, the elliptical geometry of FIG. 4D does not result in a close-packed two-dimensional tiling. As a result, flow blockages sometimes form between the tubes, and there is typically higher pressure loss ΔP across flow straightener 11. This configuration is nonetheless a preferred embodiment for a number of general-purpose fluid flow applications, to which the cutback design of flow straightener 11 continues to offer substantial advantages.

The embodiment of FIG. 4D also illustrates that, depending upon configuration and construction techniques, it is sometimes equally valid to consider that vanes 17 form flow channels 16, or that flow channels 16 form vanes 17. FIG. 4D also shows that the design of cutback flow straightener 11 encompasses both regular and irregular vane and flow channel geometries, of which FIGS. 4A-4D are merely illustrative. In particular, the design also encompasses geometries including, but not limited to, combinations of these geometries, coaxially oriented flow channel geometries, and irregular or randomized flow channel and straightener vane geometries.

Although the present invention has been described with reference to preferred embodiments, the terminology used is for the purposes of description, not limitation. Workers skilled in the art will recognize that changes may be made in form and detail without departing from the spirit and scope of the invention.

1. A cutback flow straightener comprising:
a plurality of flow straightener vanes positioned in a flow duct, wherein an axial length of the flow straightener vanes decreases as a function of a radius of the flow duct.

2. The cutback flow straightener of claim 1, wherein the flow straightener vanes form a plurality of hexagonal flow channels.

3. The cutback flow straightener of claim 1, wherein the axial length decreases by more than ten percent as a function of the radius of the flow duct.

4. The cutback flow straightener of claim 1, wherein the flow straightener vanes are cut back at an angle of at least ten degrees with respect to the radius of the flow duct.

5. The cutback flow straightener of claim 4, wherein the angle is no greater than thirty degrees with respect to the radius of the flow duct.

6. The cutback flow straightener of claim 5, wherein the angle is between twenty-one degrees and twenty-two degrees with respect to the radius of the flow duct.

7. The cutback flow straightener of claim 1, wherein a maximum value of the axial length is less than three times the radius of the flow duct.

8. The cutback flow straightener of claim 1, wherein the cutback flow straighter vanes reduce wake field intensity at an inner wall of the flow duct by at least thirty percent with respect to a non-cutback design.

9. The cutback flow straightener of claim 1, further comprising a primary flow straightener comprising a plurality of primary flow straightener vanes positioned in the flow duct, in an upstream direction with respect to the cutback flow straightener.

10. The cutback flow straightener of claim 9, wherein a minimum axial separation between the primary flow straightener and the cutback flow straightener is greater than the radius and less than three times the radius of the flow duct.

12. A flow measurement system comprising:
a turbine flow meter having a rotor positioned within a flow duct; and
a flow straightener positioned in an upstream direction from the rotor, the flow straightener comprising a plurality of cutback flow channels that are cut back from the rotor as a function of a radius of the flow duct.

11. The flow measurement system of claim 12, wherein at least one of the cutback flow channels has a hexagonal cross section.

15. The flow measurement system of claim 12, wherein at least one of the cutback flow channels has a cross section that is rectangular, triangular, or elliptical.

14. The flow measurement system of claim 12, wherein the cutback flow channels are cut back at an angle of no greater than thirty degrees with respect to the radius of the flow duct.

17. The flow measurement system of claim 14, wherein the angle is at least ten degrees with respect to the radius of the flow duct.

16. The flow measurement system of claim 12, wherein the cutback flow channels support the turbine flow meter axially within the flow duct when subject to a cryogenic fluid flow rate greater than one hundred liters per second.

13. The flow measurement system of claim 12, wherein the cryogenic fluid flow rate comprises at least one of a liquid hydrogen flow rate or a liquid oxygen flow rate.

18. A method for straightening flow, the method comprising:
positioning a primary flow straightener within a flow duct; and
positioning a secondary flow straightener within the flow duct, in a downstream direction from the primary flow straightener, wherein the secondary flow straightener has a decreasing axial length as a function of a radius of the flow duct.

19. The method of claim 18, wherein the axial length decreases by at least ten percent with respect to the radius of the flow duct.

20. The method of claim 18, wherein a maximum total length of the flow straightener is less than ten times the radius of the flow duct.
